(19) United States
(12) Patent Application Publication
(10) Pub. No.: US 2008/0179328 A1
(43) Pub. Date: Jul. 31, 2008

(54) Wooden Stemmed Drinking Utensil

(76) Inventor: Kelli Anderson, Colorado Springs, CO (US)

Correspondence Address: HOLLAND & HART LLP, 60 E. South Temple, Suite 2000, P.O. Box 11583, Salt Lake City, UT, 84110, US

(21) Appl. No.: 11/627,017

(22) Filed: Jan. 25, 2007

(51) Int. Cl. B65D 25/24; B65D 1/42; B23P 19/04

(52) U.S. Cl. 220/475; 220/636; 29/700

(57) ABSTRACT

A drinking utensil is disclosed comprising a bowl portion having an open top end and a closed bottom end, a wooden stem portion having a bottom end and a top end adhered to the closed bottom end of the bowl portion, and a base portion provided on the bottom end of the stem portion. The wood used to form the stem portion may correspond to a color or a region of origin of a beverage to be served in the drinking utensil. The wood used to form the stem portion may also correspond to the type of wood that is used to form a barrel in which a beverage to be served in the drinking utensil is aged. A corresponding method of making a drinking utensil is also disclosed.

### FIELD OF THE INVENTION

The instant disclosure relates generally to the field of drinking implements and utensils, such as wine glasses and similar stemware.

### BACKGROUND

A wine glass is a type of stemware that is used to drink and taste wine. Conventional wine glasses typically comprise a bowl portion, a vertical stem portion extending from the bowl portion, and a base portion provided proximate the bottom end of the vertical stem portion. The bowl portion is generally structured to retain a serving of wine and may be shaped so as to concentrate the aroma (or bouquet) of a wine to emphasize the wine's characteristics. The bowl portion of the wine glass may also be shaped to direct the wine into a preferred area of the mouth, such as near the lips or toward the back of the mouth. The stem portion of a wine glass provides a way to hold the glass without warming the wine from body heat and allows a drinker to hold the wine glass without leaving fingerprints on the bowl portion of the glass. The base portion of the glass provides a stable base for the wine glass to allow the glass to stand on its own.

In recent years, studies have indicated that the shape, size, and even color of the various portions of a wine glass may influence the aroma, taste, or drinker's perception of a wine. For this reason, skilled artisans have tailored the shape and size of the bowl portion of wine glasses for serving specific types of wine. For example, conventional red wine glasses typically comprise a wider and rounder bowl portion, which allows a greater portion of the red wine to aerate by interacting with the surrounding air. In contrast, white wine glasses generally comprise a narrower bowl portion with relatively straight or tulip-shaped sides. The reduced surface area of this narrow bowl portion (in comparison with red wine glasses) limits the amount of air circulating around the wine glass and the wine to help chilled wine retain a preferred temperature. Similarly, champagne glasses generally comprise a tall, narrow bowl portion. The narrow bowl portion reduces the surface area at the open top end, thus allowing the champagne to retain a greater portion of its carbonation.

Conventional wine glasses and stemware, however, suffer from a number of drawbacks and deficiencies. For example, the stem portions of conventional wine glasses, which are typically made entirely from glass or crystal, are prone to break or shatter when certain forces are applied, such as when a drinker forcefully places the wine glass on a table or other hard surface. In addition, the glass or crystal stem portion may tend to conduct greater amounts of heat than a stem portion formed from other materials, such that body heat from a drinker's hand may pass from the stem portion to the bowl portion to undesirably warm the beverage contained in the bowl portion. Moreover, as opposed to bowl portions, conventional stem portions have not been adapted to enhance the aroma, taste, or drinker's perception of a beverage served in the drinking utensil.

Accordingly, there exists a need for an improved drinking utensil and corresponding method of making the same.

### SUMMARY

According to at least one embodiment, a drinking utensil comprises a bowl portion having an open top end and a closed bottom end, a wooden stem portion having a bottom end and a top end adhered to the closed bottom end of the bowl portion, and a base portion provided on the bottom end of the stem portion. In certain embodiments, the bowl portion may be formed of glass or crystal. In addition, the base portion and the stem portion may be formed from a single piece of wood. Alternatively, the base portion may be formed of glass or crystal and may be adhered to the bottom end of the stem portion.

In at least one embodiment, the wood used to form the stem portion may correspond to a region of origin of a beverage to be served in the drinking utensil. For example, the region of origin of the beverage may be Italy and the wood used to form the stem portion may be Atinian elm. Similarly, the region of origin of the beverage may be France and the wood used to form the stem portion may be European yew. In addition, the region of origin of the beverage may be Spain and the wood used to form the stem portion may be holm oak. The region of origin of the beverage may also be California and the wood used to form the stem portion may be California redwood.

In an additional embodiment, the wood used to form the stem portion may correspond to a color of a beverage to be served in the drinking utensil. For example, the beverage to be served in the drinking utensil may be a white wine and the wood used to form the stem portion may be white oak. Similarly, the beverage to be served in the drinking utensil may be a red wine and the wood may be mahogany. In additional embodiments, the wood used to form the stem portion may correspond to the type of wood that is used to form a barrel in which a beverage to be served in the drinking utensil is aged. In addition, the stem portion may comprise an inscription indicating the region of origin of a beverage to be served in the drinking utensil and/or the color of the beverage to be served in the drinking utensil.

In certain embodiments, a drinking utensil comprises a bowl portion having an open top end and a closed bottom end, a wooden stem portion having a bottom end and a top end removably attached to the closed bottom end of the bowl portion, and a base portion provided on the bottom end of the stem portion. In at least one embodiment, the stem portion may comprise a threaded insert provided proximate its top end, while the bowl portion may comprise a threaded aperture provided proximate its closed bottom end and configured to receive the threaded insert.

In at least one embodiment, a wine glass comprises a bowl portion comprising an open top end and a closed bottom end, a wooden stem portion having a bottom end and a top end adhered to the closed bottom end of the bowl portion, and a wooden base portion provided on the bottom end of the stem portion. The bowl portion may be formed of glass or crystal and the base portion and the stem portion may be formed from a single piece of wood. In addition, the wood used to form the wooden stem portion may correspond to a region of origin of a wine to be served in the wine glass.

In an additional embodiment, a method of making a drinking utensil comprises providing a bowl portion having an open top end and a closed bottom end, providing a wooden stem portion having a top end and a bottom end, adhering the top end of the wooden stem portion to the closed bottom end of the bowl portion, and providing a base portion on the bottom end of the wooden stem portion. In certain embodiments, the method may also comprise selecting the wood used to form the wooden stem portion based on the region of origin of a beverage to be served in the drinking utensil. In addition, the method may also comprise selecting the wood used to form the wooden stem portion based on the color of a beverage to be served in the drinking utensil. The method may also comprise selecting the wood used to form the wooden stem portion based on a type of wood used to form a barrel in which a beverage to be served in the drinking utensil is aged.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an exemplary drinking utensil according to at least one embodiment;

FIG. 2 is a perspective view of an exemplary drinking utensil according to an additional embodiment;

FIG. 3 is a perspective view of an exemplary drinking utensil according to an additional embodiment; and

FIG. 4 is a partial cross-sectional side view of the exemplary drinking utensil illustrated in FIG. 3; and

FIG. 5 is a flow diagram of an exemplary method for making a drinking utensil.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, one of skill in the art will understand that the exemplary embodiments described herein are not intended to be limited to the particular forms disclosed. Rather, the instant disclosure covers all modifications, equivalents, and alternatives falling within the scope defined by the appended claims.

### DETAILED DESCRIPTION OF EXEMPLARY EMBODIMENTS

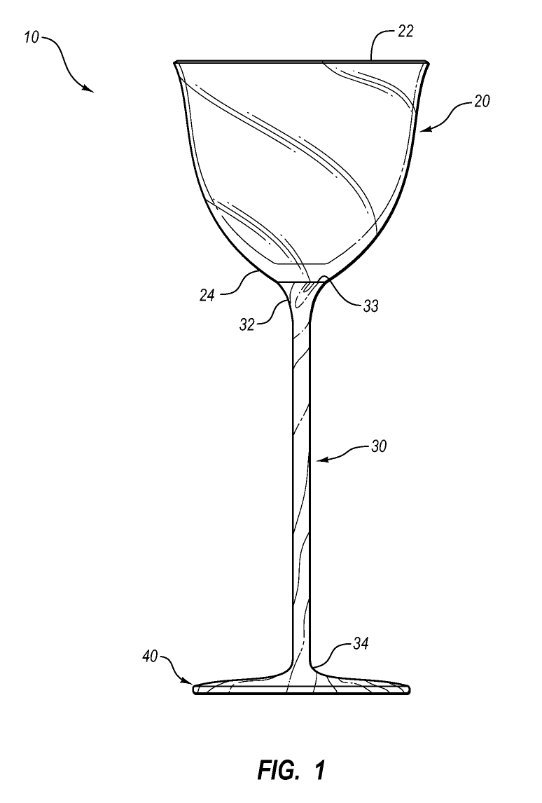

FIG. 1 is a perspective view of an exemplary drinking utensil 10 according to at least one embodiment. As seen in this figure, in at least one embodiment exemplary drinking utensil 10 may comprise a bowl portion 20, a stem portion 30, and a base portion 40. Bowl portion 20 is generally structured to receive and contain a serving of a beverage, such as wine. In certain embodiments, bowl portion 20 may comprise an open top end 22 and a closed bottom end 24. Bowl portion 20 may also be formed in any number of shapes and sizes. For example, in certain embodiments bowl portion 20 may comprise a relatively wide open end 22, as is common with conventional red wine glasses. Alternatively, bowl portion 20 may comprise a relatively narrow open end 22, as is common with conventional white wine or champagne glasses. Bowl portion 20 may also be formed of any number or combination of materials; including, for example, glass (including fused, blown, or cut glass), crystal, plastic, or the like.

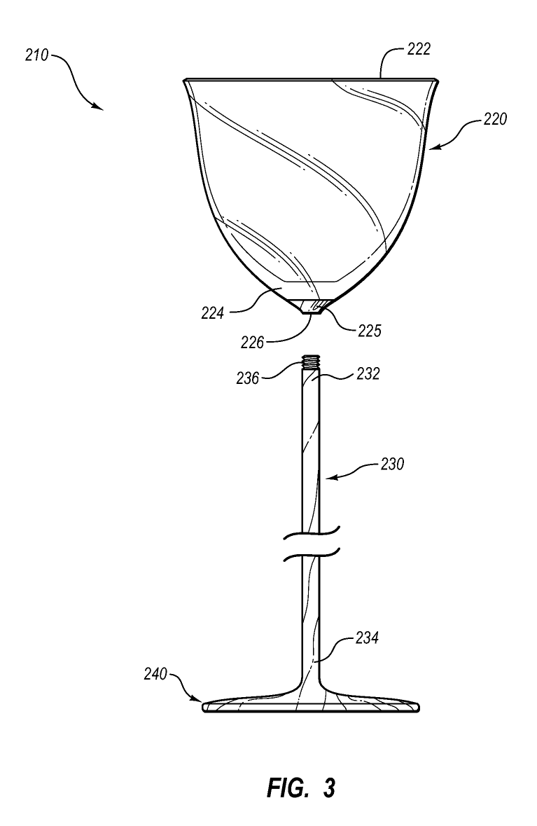

Stem portion 30 is generally structured to support bowl portion 20 and to provide a portion by which drinking utensil 10 may be held or grasped by a user. In many embodiments, stem portion 30 comprises a bottom end 34 and a top end 32 affixed to the bottom end 24 of bowl portion 20. As with bowl portion 20, stem portion 30 may be formed in any number of shapes and sizes. For example, stem portion 30 may be formed so as to be relatively long and slender or, alternatively, short and stubby. In at least one embodiment, the top end 32 of stem portion 30 may be adhered to the bottom end 24 of bowl portion 20 by a suitable adhesive 33. Additionally or alternatively, as discussed in detail below in connection with FIG. 3, stem portion 30 may comprise a threaded end configured to be removably received within a threaded aperture defined within the bottom end 24 of bowl portion 20.

Stem portion 30 may be formed of any number or combination of materials; including, for example, glass, crystal, or plastic. Alternatively, in at least one embodiment stem portion 30 may be made of or turned from wood. In certain embodiments, stem portion 30 may be made of or turned from a wood having a color that corresponds to the color of a beverage to be served in drinking utensil 10. For example, in embodiments where the shape of bowl portion 20 is tailored for serving red wines (i.e., when bowl portion 20 comprises a relatively wide open end 22), stem portion 30 may be formed from a dark colored wood, such as, for example, mahogany (Swietenia macrophylla), black cherry (Prunus serotina), red alder (Alnus rubra), black walnut (Juglans nigra), Brazilian rosewood (Dalbergia nigra), teak (Tectona grandis), or the like. Similarly, in embodiments where the shape of bowl portion 20 is tailored for serving white wines (i.e., when bowl portion 20 comprises a relatively narrow open end 22), stem portion 30 may be formed from a light colored wood, such as, for example, white oak (Quercus alba), white ash (Fraxinus americana), white poplar (Populus alba), or any other desirable or suitable wood.

In an additional embodiment, stem portion 30 may be made of or turned from a wood that is endemic to or commonly found in the region of origin of a beverage to be served in drinking utensil 10. In other words, the wood used to form stem portion 30 may share a common region of origin with the beverage to be served in drinking utensil 10. For example, in embodiments where a wine made in Italy is to be served in drinking utensil 10, stem portion 30 may be made of or turned from wood that is endemic to or commonly found in Italy, such as, for example, Atinian elm (Ulmus minor var. vulgaris). Similarly, in embodiments where a wine made in France is to be served in drinking utensil 10, stem portion 30 may be made of or turned from wood that is endemic to or commonly found in France, such as, for example, European yew (Taxus baccata). In addition, in embodiments where a wine made in Spain is to be served in drinking utensil 10, stem portion 30 may be made of or turned from wood that is endemic to or commonly found in Spain, such as, for example, holm oak (Quercus ilex). Additionally or alternatively, in embodiments where a wine made in California is to be served in drinking utensil 10, stem portion 30 may be made of or turned from wood that is endemic to or commonly found in California, such as, for example, California redwood (Sequoia sempervirens). Additional types of wood that are endemic to or commonly found in other regions where wine is made may also be chosen as desired.

In an additional embodiment, stem portion 30 may be made of or turned from a wood that matches the type of wood that is used to form the barrels in which a beverage, such as wine, is aged. As is known to those of skill in the art, certain wines are aged in barrels made from specific types of wood. During the aging process, the type of wood used to form the barrel imparts specific characteristics and distinctive flavors to the wine. More specifically, the wine takes on some of the organic compounds present in the wooden barrel, such as vanillin and wood tannins, thus coloring the aroma and flavor of the resulting wine. The presence of these organic compounds is dependent on many factors; including, for example, the region of origin of the wood, how the staves used to form the barrel were cut and dried, and the degree of “toast” applied to the wooden barrel during manufacture.

Accordingly, in at least one embodiment, the wood used to form stem portion 30 may match the type of wood that is used to form the barrels in which a beverage, such as wine, is aged. For example, in embodiments where a wine aged in an American oak barrel is to be served in drinking utensil 10, stem portion 30 may be made of or turned from American oak. Similarly, in embodiments where a wine aged in a French oak barrel is to be served in drinking utensil 10, stem portion 30 may be made of or turned from French oak. Stem portion 30 may also be made of or turned from any number of other woods used to form wine barrels, such as California redwood or sweet chestnut (Castanea sativa).

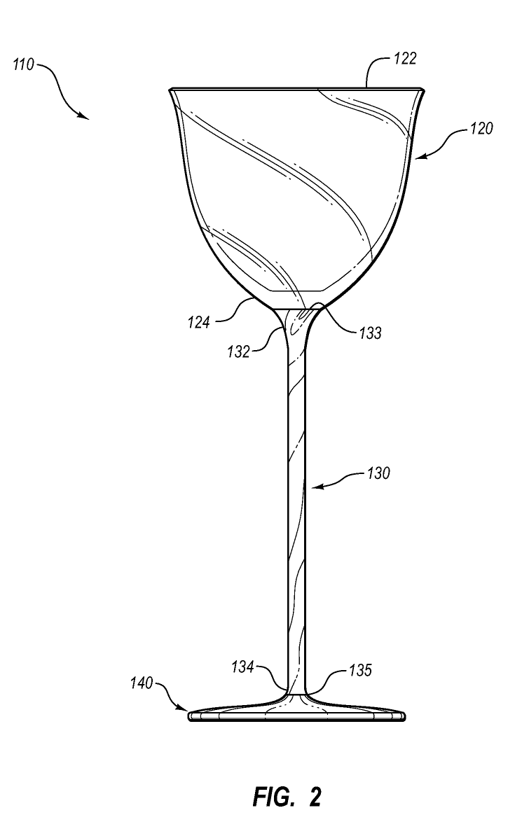

As seen in FIG. 1, base portion 40 generally provides a stable base for drinking utensil 10, thereby permitting drinking utensil 10 to stand on its own. Base portion 40 may be formed in any number of shapes and sizes and of any number or combination of materials. For example, in the exemplary embodiment illustrated in FIG. 1, base portion 40 may be formed from the same portion of wood from which stem portion 30 is made of or turned. Alternatively, as illustrated in FIG. 2, base portion 140 may be formed of crystal or glass and adhered to the bottom end 134 of wooden stem portion 130 by an adhesive 135.

In at least one embodiment, bowl portion 20, stem portion 30, and/or base portion 40 may comprise an inscription indicating the type of wood used to form stem portion 30, the region of origin of the wood used to form stem portion 30, the region of origin of the wine to be served in drinking utensil 10, and/or the color of wine to be served in drinking utensil 10. For example, when stem portion 30 is made of or turned from wood that is native or endemic to France, stem portion 30 may be engraved with an inscription that reads “French Wine Glass.” Similarly, in embodiments where drinking utensil 10 is tailored for serving red wines (i.e., when bowl portion 20 comprises a relatively wide open end 22 and when stem portion 30 is made of or turned from a dark colored wood), stem portion 30 may be engraved with an inscription that reads “Red Wine Glass.” Additionally or alternatively, in embodiments where stem portion 30 is made of or turned from a wood that is native or endemic to Tuscany, Italy, stem portion 30 may be engraved with an inscription that reads “Tuscany, Italy.”

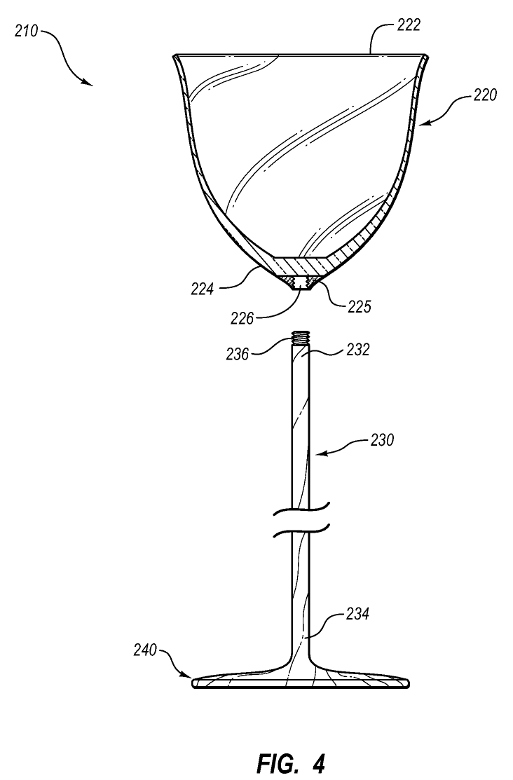

FIGS. 3 and 4 are perspective and cross-sectional side views, respectively, of an exemplary drinking utensil 210 according to an additional embodiment. As seen in these figures, in at least one embodiment exemplary drinking utensil 210 may comprise a bowl portion 220, a stem portion 230, and a base portion 240. As with bowl portion 20, bowl portion 220 may comprise an open top end 222 and a closed bottom end 224. Bowl portion 220 may also be formed of any number or combination of materials; including, for example, glass (including fused, blown, or cut glass), crystal, plastic, or the like.

In many embodiments, stem portion 230 comprises a top end 232 and a bottom end 234. In the exemplary embodiment illustrated in FIGS. 3-4, stem portion 230 may comprise a threaded insert 236 provided on its top end 232. In at least one embodiment, threaded insert 236 may be configured to be removably received within a threaded aperture 226 defined within a wooden portion 225 adhered to the bottom end 224 of bowl portion 220. Accordingly, stem portion 230 may be removably attached or removed from bowl portion 220 as desired. For example, various stem portions 230 made of or turned from a variety of different woods may be mixed and matched with bowl portion 220 as desired for serving differing types of beverages.

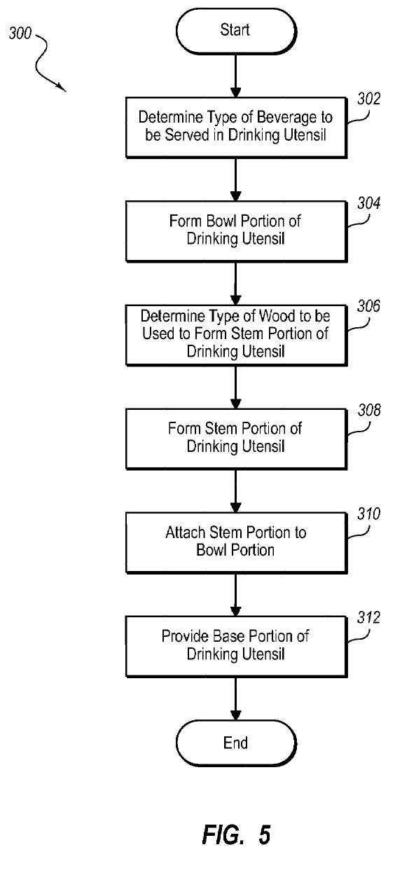

FIG. 5 is a flow diagram of an exemplary method 300 for making a drinking utensil. As seen in this figure, at step 302 the type or characteristics (such as the color or region of origin) of a beverage to be served in the drinking utensil may be determined. Then, at step 304, the bowl portion of the drinking utensil (such as, for example, bowl portion 20) may be formed. As detailed above, the bowl portion may be formed in any number of shapes and sizes. For example, in certain embodiments the bowl portion may comprise a relatively wide open end, as is common with conventional red wine glasses. Alternatively, the bowl portion may comprise a relatively narrow open end, as is common with conventional white wine or champagne glasses.

At step 306, the type of wood to be used in forming the stem portion of the drinking utensil may be determined. As detailed above, the type of wood used to form the stem portion of the drinking utensil may correspond to the color or region of origin of a beverage to be served in the drinking utensil. The stem portion may also be made of or turned from a wood that matches the type of wood that is used to form the barrels in which a beverage to be served in the drinking utensil has been aged. At step 308, the stem portion may be made of or turned from the wood chosen at step 306. As explained above, the stem portion may be formed in any number of shapes and sizes.

At step 310, the stem portion may be attached to the bottom end of the bowl portion formed in step 304. As detailed above, in at least one embodiment, the top end of the stem portion may be adhered to the bottom end of the bowl portion of the drinking utensil by a suitable adhesive. Additionally or alternatively, as discussed above in connection with FIG. 3, the stem portion may comprise a threaded end configured to be removably received within a threaded aperture defined within the bottom end of the bowl portion. At step 312, a base portion of the drinking utensil may be provided. As explained above, this base portion may be made of or turned from the same portion of wood used to form the stem portion or, alternatively, formed of glass or crystal and adhered to the bottom end of the stem portion. Upon completion of step 312, the exemplary method may terminate.

The various embodiments of the exemplary drinking utensil described and/or illustrated herein may provide a number of benefits over conventional stemware. For example, the stem portion of this exemplary drinking utensil may possess greater insulating characteristics than the stem portions of conventional stemware. Specifically, because the stem portion may be made of or turned from wood, as opposed to being formed of glass or crystal, this wooden stem portion may be less likely to transfer heat from a drinker's hand to the bowl portion than might occur with a conventional stem portion formed of glass or crystal, thus allowing a chilled beverage contained in the bowl portion to maintain a preferred temperature. In addition, the wooden stem portion may be less likely to shatter or break than conventional stem portions formed of glass or crystal, resulting in a safer and more durable drinking utensil.

In addition, the natural color or scent of the wood used to form the stem portion may enhance the aroma, taste, or drinker's perception of a beverage, such as wine, served in the drinking utensil described herein. For example, when a Californian white wine that was aged in a white oak barrel is served in a drinking utensil having a stem portion formed of white oak, the natural scent of the white oak stemmed portion may further enhance or color the aroma, flavor, or drinker's perception of the white wine. Similarly, the color of the wood used to form the stem portion may, when matched with the color of a beverage to be served in the drinking utensil, influence a drinker's perception of the beverage. For example, the color of a stem portion made of or turned from red alder (Alnus rubra) may enhance the natural color of a red wine served in the drinking utensil, thus enhancing the drinker's perception and appreciation of the wine.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative and not restrictive and that reference be made to the appended claims and their equivalents for determining the scope of the instant disclosure. In addition, for ease of use, the words “including” and “having,” as used in the specification and claims, are interchangeable with and have the same meaning as the word “comprising.”

What is claimed is:

1. A drinking utensil, comprising:
a bowl portion comprising an open top end and a closed bottom end;
a stem portion having a bottom end and a top end adhered to the closed bottom end of the bowl portion;
a base portion provided on the bottom end of the stem portion;
wherein the stem portion comprises wood.

2. The drinking utensil of claim 1, wherein the bowl portion is formed of glass or crystal.

3. The drinking utensil of claim 1, wherein the base portion and the stem portion are formed from a single piece of wood.

4. The drinking utensil of claim 1, wherein the base portion is formed of glass or crystal and is adhered to the bottom end of the stem portion.

5. The drinking utensil of claim 1, wherein the wood used to form the stem portion corresponds to a region of origin of a beverage to be served in the drinking utensil.

6. The drinking utensil of claim 5, wherein the region of origin of the beverage is Italy and the wood is Atinian Elm.

7. The drinking utensil of claim 5, wherein the region of origin of the beverage is France and the wood is European Yew.

8. The drinking utensil of claim 5, wherein the region of origin of the beverage is Spain and the wood is Holm Oak.

9. The drinking utensil of claim 5, wherein the region of origin of the beverage is California and the wood is California Redwood.

10. The drinking utensil of claim 1, wherein the wood used to form the stem portion corresponds to a color of a beverage to be served in the drinking utensil.

11. The drinking utensil of claim 10, wherein the beverage is a white wine and the wood is white oak.

12. The drinking utensil of claim 10, wherein the beverage is a red wine and the wood is mahogany.

13. The drinking utensil of claim 1, wherein the wood used to form the stem portion corresponds to a type of wood used to form a barrel in which a beverage to be served in the drinking utensil is aged.

14. The drinking utensil of claim 1, wherein the stem portion further comprises an inscription indicating at least one of the region of origin of a beverage to be served in the drinking utensil and the color of the beverage to be served in the drinking utensil.

15. A drinking utensil, comprising:
a bowl portion comprising an open top end and a closed bottom end;
a stem portion having a bottom end and a top end removably attached to the closed bottom end of the bowl portion;
a base portion provided on the bottom end of the stem portion;
wherein the stem portion comprises wood.

16. The drinking utensil of claim 15, wherein the stem portion comprises a threaded insert provided proximate its top end and the bowl portion comprises a threaded aperture provided proximate its closed bottom end and configured to receive the threaded insert.

17. A wine glass, comprising:
a bowl portion comprising an open top end and a closed bottom end;
a wooden stem portion having a bottom end and a top end adhered to the closed bottom end of the bowl portion;
a wooden base portion provided on the bottom end of the stem portion;
wherein the bowl portion is formed of glass or crystal;
wherein the base portion and the stem portion are formed from a single piece of wood;
wherein the wood used to form the wooden stem portion corresponds to a region of origin of a wine to be served in the wine glass;
wherein the wooden stem portion comprises an inscription indicating the region of origin of the wine to be served in the wine glass.

18. A method of making a drinking utensil, comprising:
providing a bowl portion comprising an open top end and a closed bottom end;
providing a wooden stem portion having a top end and a bottom end;
adhering the top end of the wooden stem portion to the closed bottom end of the bowl portion;
providing a base portion on the bottom end of the wooden stem portion.

19. The method of claim 18, further comprising selecting the wood used to form the wooden stem portion based on the region of origin of a beverage to be served in the drinking utensil.

20. The method of claim 18, further comprising selecting the wood used to form the wooden stem portion based on the color of a beverage to be served in the drinking utensil.

21. The method of claim 18, further comprising selecting the wood used to form the wooden stem portion based on a type of wood used to form a barrel in which a beverage to be served in the drinking utensil is aged.
